(19) United States
(12) Patent Application Publication
(10) Pub. No.: US 2025/0325926 A1
(43) Pub. Date: Oct. 23, 2025

(54) FILTER ASSEMBLY AND CONNECTING COVER ADAPTED FOR FILTER ASSEMBLY

(71) Applicant: PA.E Machinery Industrial Co., Ltd., Taichung City (TW)

(72) Inventor: Ming-Yu Lai, Taichung City (TW)

(73) Assignee: PA.E Machinery Industrial Co., Ltd., Taichung City (TW)

(21) Appl. No.: 18/805,840

(22) Filed: Aug. 15, 2024

(30) Foreign Application Priority Data
Apr. 18, 2024 (TW) 113114537

(51) Int. Cl. B01D 29/11; B01D 29/13

(52) U.S. Cl. CPC B01D 29/111; B01D 29/13; B01D 2201/043; B01D 2201/4038

(57) ABSTRACT

A filter assembly includes a connecting cover and two filter tubes. The connecting cover includes a tubular wall, a partition plate, and two clamping rings. The tubular wall has an inner wall surface. The partition plate extends in a transverse direction, and has two abutment surfaces and a through hole. The inner wall surface and the abutment surfaces cooperatively define two insertion slots each of which opens unidirectionally. The clamping rings respectively protrude from the abutment surfaces. The two filter tubes are mounted respectively to the insertion slots. Each filter tube has two end surfaces, an outer annular surface, and an inner hole. For each filter tube, one of the end surfaces that is adjacent to the connecting cover abuts against a corresponding one of the abutment surfaces. The clamping rings are respectively inserted into the filter tubes.

### CROSS-REFERENCE TO RELATED APPLICATION

This application claims priority to Taiwanese Invention patent application No. 113114537, filed on Apr. 18, 2024, the entire disclosure of which is incorporated by reference herein.

### FIELD

The disclosure relates to a water purifier, and more particularly to a filter assembly and a connecting cover adapted for the filter assembly.

### BACKGROUND

A conventional filter of a water purifier adapted for improving water quality is usually made of a polypropylene (PP) melt blown material. However, lengths of the conventional filters on the market are various, including 20 inches, 30 inches, or even 40 inches. In addition to increasing difficulty in manufacturing, managerial costs and inventory costs of the conventional filters may also be increased.

### SUMMARY

Therefore, an object of the disclosure is to provide a filter assembly that can alleviate at least one of the drawbacks of the prior art.

According to the disclosure, the filter assembly includes a connecting cover and two filter tubes.

The connecting cover includes a tubular wall surrounding an axis, a partition plate connected transversely to the tubular wall, and at least two clamping rings protruding from the partition plate. The tubular wall has an inner wall surface. The partition plate extends in a transverse direction that is transverse to the axis, and has two abutment surfaces that are opposite to each other and a through hole that is in spatial communication with the abutment surfaces. The inner wall surface and the abutment surfaces cooperatively define two insertion slots each of which opens unidirectionally. The clamping rings respectively protrude from the abutment surfaces.

The two filter tubes are mounted respectively to the insertion slots. Each of the filter tubes has two end surfaces that are opposite to each other along the axis, an outer annular surface that interconnects peripheries of the end surfaces, and an inner hole that is aligned with the axis and that is in spatial communication with the through hole. For each of the filter tubes, one of the end surfaces that is adjacent to the connecting cover abuts against a corresponding one of the abutment surfaces. The clamping rings are respectively inserted into the filter tubes.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a planar assembly view of an embodiment of a filter assembly according to the disclosure.

FIG. 2 is a sectional view taken along line II-II of FIG. 1.

FIG. 3 is a perspective view of an embodiment of a connecting cover according to the disclosure.

FIG. 4 is a cross-sectional view of another embodiment of the connecting cover according to the disclosure.

FIG. 5 is a cross-sectional view of yet another embodiment of the connecting cover of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

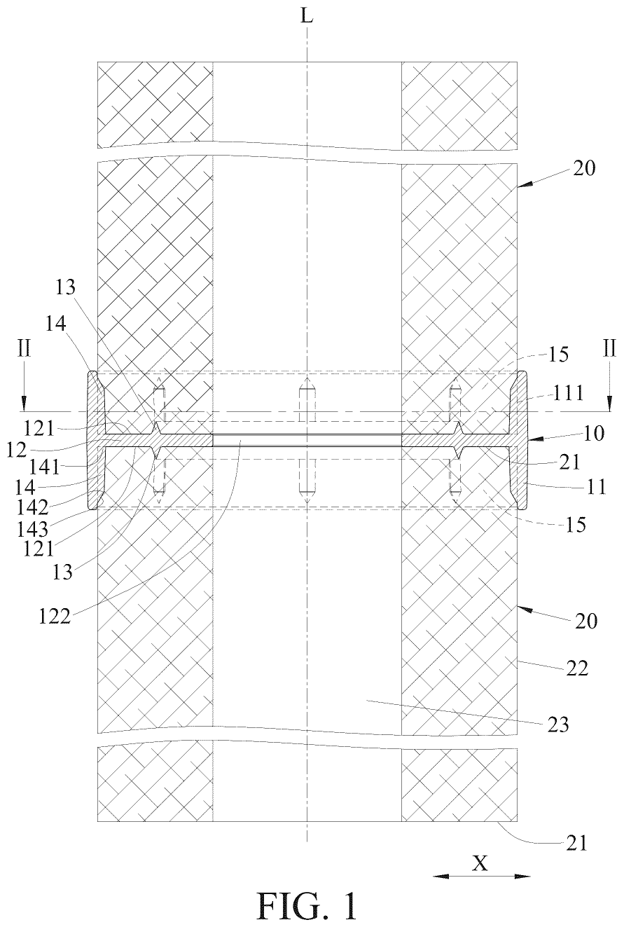

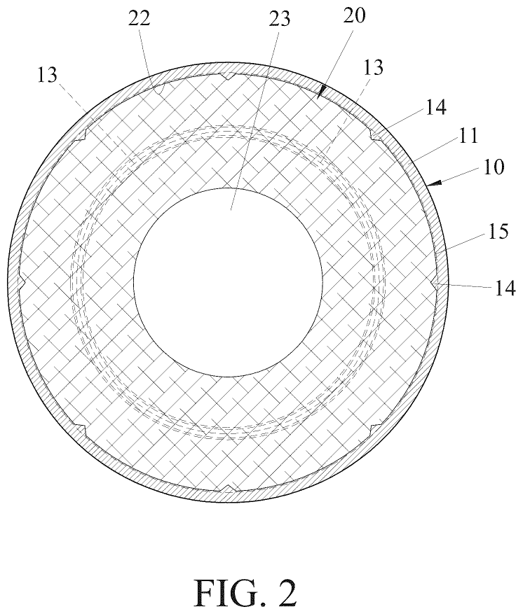

Referring to FIGS. 1 and 2, an embodiment of a filter assembly according to the disclosure includes a connecting cover 10 and two filter tubes 20.

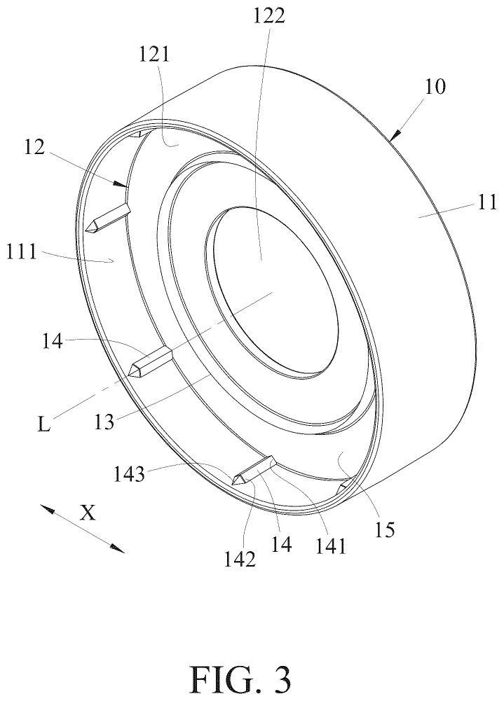

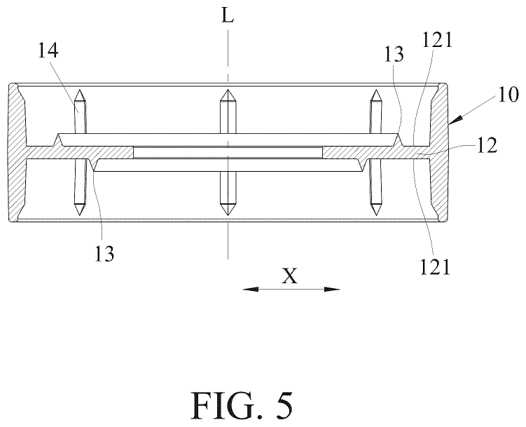

Referring further to FIG. 3, the connecting cover 10 includes a tubular wall 11 surrounding an axis (L), a partition plate 12 connected transversely to the tubular wall 11, two clamping rings 13 protruding from the partition plate 12, and a plurality of engaging bars 14 disposed spaced apart from each other around the axis (L). The tubular wall 11 has an inner wall surface 111. The partition plate 12 extends in a transverse direction (X) that is transverse to the axis (L), and has two abutment surfaces 121 that are opposite to each other, and a through hole 122 that is in spatial communication with the abutment surfaces 121 and that is aligned with the axis (L). The inner wall surface 111 and the abutment surfaces 121 cooperatively define two insertion slots 15, each of which opens unidirectionally. The clamping rings 13 are disposed around the axis (L) and respectively protrude from the abutment surfaces 121. In this embodiment, each of the abutment surfaces 121 of the partition plate 12 is provided with a respective one of the clamping rings 13. The clamping rings 13 are positioned in a corresponding manner in the transverse direction (X). Each of the clamping rings 13 has a cross section parallel to the axis (L) that is triangular. In addition, the clamping rings 13 that respectively protrude from the abutment surfaces 121 may also be positioned in an offsetting manner in the transverse direction (X) (as shown in FIG. 5, which illustrates another embodiment of the connecting cover 10 according to the disclosure).

The engaging bars 14 are disposed on the inner wall surface 111 (i.e., protrude from the inner wall surface 111) and each extends toward one of the insertion slots 15. Each of the engaging bars 14 has a triangular cross-section that is parallel to the transverse direction (X) (see FIG. 2). Each of the engaging bars 14 has a bottom end portion 141 that is connected to the partition plate 12, a top end portion 142 that is opposite to the bottom end portion 141 and that is adjacent to an opening of a corresponding one of the insertion slots 15, and a guiding taper portion 143 that is connected to the top end portion 142. A cross-sectional area of each of the engaging bars 14 that is parallel to the transverse direction (X) gradually decreases in a direction from the bottom end portion 141 to the top end portion 142. For each of the engaging bars 14, the guiding taper portion 143 is a triangular pyramid, and a cross-sectional area of the guiding taper portion 143 that is parallel to the transverse direction (X) gradually decreases in a direction from the top end portion 142 to the opening of the corresponding one of the insertion slots 15.

The filter tubes 20 are respectively mounted to the insertion slots 15. Each of the filter tubes 20 has two end surfaces 21 that are opposite to each other along the axis (L), an outer annular surface 22 that interconnects peripheries of the end surfaces 21, and an inner hole 23 that is aligned with the axis (L) and that is in spatial communication with the through hole 122. For each of the filter tubes 20, one of the end surfaces 21 that is adjacent to the connecting cover 10 substantially abuts against a corresponding one of the abutment surfaces 121. The clamping rings 13 are respectively inserted into the filter tubes 20. The outer annular surfaces 22 abut substantially against the inner wall surface 111, and each of the engaging bars 14 is inserted into one of the filter tubes 20.

To further understand the effects produced, the technical means, and the expected effects of the cooperation of various elements of the disclosure, they will be described again below, so a deeper and more specific understanding of the present disclosure may be obtained.

As shown in FIG. 1, when assembling the filter assembly, the filter tubes 20 may be respectively mounted in the insertion slots 15. By virtue of the connecting cover 10 providing secure assembly to the filter tubes 20, the filter assembly may have a predetermined length according to user requirements.

During assembly, when inserting the filter tubes 20 into the insertion slots 15, by virtue of each of the guiding taper portions 143 having a pyramid shape (i.e., the cross-sectional area of the guiding taper portion 143 that is parallel to the transverse direction (X) gradually decreases in the direction from the top end portion 142 to the opening of the corresponding one of the insertion slots 15), and by virtue of the cross-sectional area of each of the engaging bars 14 that is parallel to the transverse direction (X) gradually decreasing in the direction from the bottom end portion 141 to the top end portion 142, the engaging bars 14 can guide the filter tubes 20 to be easily inserted into the insertion slots 15.

When the end surfaces 21 of the filter tubes 20 that are adjacent to the connecting cover 10 substantially and respectively abut against the abutment surfaces 121, the clamping rings 13 are respectively inserted into the filter tubes 20. The outer annular surfaces 22 abut substantially against the inner wall surface 111, and each of the engaging bars 14 is inserted into one of the filter tubes 20. Then, the filter tubes 20 and the connecting end cover 10 are securely assembled.

Therefore, the present disclosure may provide a filter having a predetermined length by an assembling method. The method may reduce managerial costs associated with manufacturing of various lengths of filters, and offers easy assembly. That is to say, by virtue of the connecting cover 10 interconnecting the two filter tubes 20, the two filter tubes 20 each having a length of 20 inches may replace a filter tube of 40 inches. If taking a thickness of the partition plate 12 of the connecting cover 10 into consideration, a length of each of the filter tubes 20 may be slightly reduced. The two filter tubes 20 are inserted into the openings of the two insertion slots 15 of the connecting cover 10, respectively.

It is worth mentioning that an inner straight tube (not shown) made of a rigid polypropylene (PP) material may further be mounted in each of the inner holes 23 of each of the filter tubes 20, so as to increase rigidity of the filter assembly and reduce possibility of deformation of the filter tubes 20. By virtue of forming the filter assembly using multiple filter tubes in sections, the filters that are overly long are not required to be manufactured, thereby reducing manufacturing cost and difficulty.

The aforesaid embodiment of the filter assembly of the disclosure illustrates one connecting cover 10 that interconnects the two filter tubes 20. In fact, two or more connecting covers 10 may be used for interconnecting a plurality of filter tubes 20 (not shown), thereby assembling filters having different lengths.

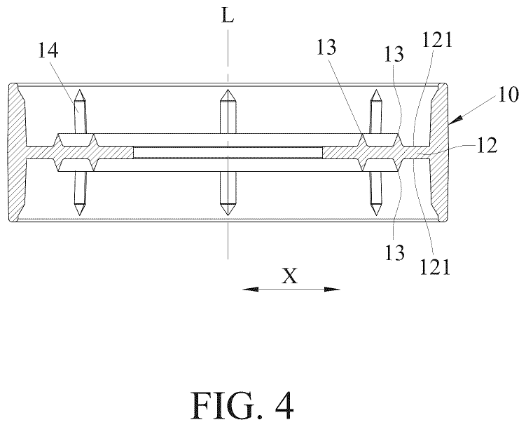

As shown in FIG. 4, another embodiment of the connecting cover 10 of the disclosure is substantially the same as the above embodiment, except that each of the abutment surfaces 121 of the partition plate 12 is provided with two clamping rings 13 disposed concentrically around the axis (L). The clamping rings 13 on one of the abutment surfaces 121 are positioned in corresponding to the clamping rings 13 on the other one of the abutment surfaces 121, respectively, in the transverse direction (X). The connecting cover 10 may achieve the same purpose and effect as those as described previously.

It is worth mentioning that, in the aforesaid embodiments, the clamping rings 13 that protrude from one of the abutment surfaces 121 may also be positioned in an offsetting manner (not shown) with respect to the clamping rings 13 that protrude from the other one of the abutment surfaces 121 in the transverse direction (X) to achieve the same object and effect as described previously.

In summary, each of the filter assembly and the connecting cover 10 adapted for the filter assembly of this disclosure has a simple structure, and is easy to manufacture and assemble, so that the object of this disclosure is indeed achieved.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A filter assembly, comprising:
a connecting cover including a tubular wall surrounding an axis, a partition plate connected transversely to said tubular wall, and at least two clamping rings protruding from said partition plate, said tubular wall having an inner wall surface, said partition plate extending in a transverse direction that is transverse to the axis, and having two abutment surfaces that are opposite to each other and a through hole that is in spatial communication with said abutment surfaces, said inner wall surface and said abutment surfaces cooperatively defining two insertion slots each of which opens unidirectionally, said clamping rings respectively protruding from said abutment surfaces; and
two filter tubes mounted respectively to said insertion slots, each of said filter tubes having two end surfaces that are opposite to each other along the axis, an outer annular surface that interconnects peripheries of said end surfaces, and an inner hole that is aligned with the axis and that is in spatial communication with said through hole, for each of said filter tubes, one of said end surfaces that is adjacent to said connecting cover abutting against a corresponding one of said abutment surfaces, said clamping rings being respectively inserted into said filter tubes.

2. The filter assembly as claimed in claim 1, wherein said clamping rings of said connecting cover are disposed around the axis, protrude respectively from said abutment surfaces, and are positioned in a corresponding manner in the transverse direction.

3. The filter assembly as claimed in claim 1, wherein said clamping rings of said connecting cover are disposed around the axis, protrude respectively from said abutment surfaces, and are positioned in an offsetting manner in the transverse direction.

4. The filter assembly as claimed in claim 1, wherein said connecting cover further includes a plurality of engaging bars that are disposed spaced apart from each other about the axis, each of said engaging bars protruding from said inner wall surface and extending toward one of said insertion slots.

5. The filter assembly as claimed in claim 4, wherein each of said engaging bars of said connecting cover has a triangular cross-section that is parallel to the transverse direction, said outer annular surfaces of said filter tubes abutting against said inner wall surface, each of said engaging bars being inserted into one of said filter tubes.

6. The filter assembly as claimed in claim 5, wherein each of said engaging bars of said connecting cover includes a bottom end portion that is connected to said partition plate, a top end portion that is opposite to said bottom end portion and that is adjacent to an opening of a corresponding one of said insertion slots, and a guiding taper portion that is connected to said top end portion, a cross-sectional area of each of said engaging bars that is parallel to the transverse direction gradually decreasing in a direction from said bottom end portion to said top end portion, a cross-sectional area of said guiding taper portion that is parallel to the transverse direction gradually decreasing in a direction from said top end portion to said opening of said corresponding one of said insertion slots.

7. A connecting cover adapted for a filter assembly, comprising a tubular wall surrounding an axis, a partition plate connected transversely to said tubular wall, and at least two clamping rings protruding from said partition plate, said tubular wall having an inner wall surface, said partition plate extending in a transverse direction that is transverse to the axis, and having two abutment surfaces that are opposite to each other and a through hole that is in spatial communication with said abutment surfaces, said inner wall surface and said abutment surfaces cooperatively defining two insertion slots each of which opens unidirectionally, said clamping rings respectively protruding from said abutment surfaces.

8. The connecting cover as claimed in claim 7, wherein said clamping rings of said connecting cover are disposed around the axis, protrude respectively from said abutment surfaces, and are positioned in a corresponding manner in the transverse direction.

9. The connecting cover as claimed in claim 7, wherein said clamping rings of said connecting cover are disposed around the axis, protrude respectively from said abutment surfaces, and are positioned in an offsetting manner in the transverse direction.

10. The connecting cover as claimed in claim 7, wherein said connecting cover further includes a plurality of engaging bars that are disposed spaced apart from each other about the axis, each of said engaging bars protruding from said inner wall surface and extending toward one of said insertion slots.
